(19) United States
(12) Patent Application Publication
(10) Pub. No.: US 2020/0143670 A1
(43) Pub. Date: May 7, 2020

(54) VEHICLE ELECTRONIC CONTROLLER

(71) Applicant: HITACHI AUTOMOTIVE SYSTEMS, LTD., Ibaraki (JP)

(72) Inventors: Mitsuhiro KITANI, Tokyo (JP); Masayoshi ISHIKAWA, Tokyo (JP); Tsuneo SOBUE, Tokyo (JP); Hiroaki ITOU, Hitachinaka-shi (JP)

(21) Appl. No.: 16/607,486

(22) PCT Filed: Apr. 13, 2018
(86) PCT No.: PCT/JP2018/015511

§ 371 Date: Oct. 23, 2019

(30) Foreign Application Priority Data
Apr. 28, 2017 (JP) 2017-089825

(51) Int. Cl. G08G 1/048; G06K 9/00; G07C 5/08; G06N 3/04

(52) U.S. Cl. CPC G08G 1/048; G06N 3/04; G07C 5/0816; G06K 9/00805

(57) ABSTRACT

A vehicle electronic controller includes a status acquiring unit configured to acquire status of a vehicle, and a determining unit configured to determine whether to configure an artificial intelligence model based on the status of the vehicle acquired at the status acquiring unit. When the determining unit determines that the artificial intelligence model is configured, an artificial intelligence model configured to execute a predetermined process is configured by combination of a plurality of operation units.

### TECHNICAL FIELD

The present invention relates to a vehicle electronic controller.

### BACKGROUND ART

Nowadays, the development of automatic driving systems is being stimulated. In the automatic driving system, in order to drive in a complicated driving environment, the sophistication of functions is necessary, which are “recognition” that senses an environment surrounding a host vehicle based on information from various sensors, such as cameras, laser radars, and millimeter wave radars, “cognition” that estimates how an object behaves in future, which has been detected by a sensor and surrounds the host vehicle, and “determination” that plans the behavior of the host vehicle in future based on the results of recognition and cognition. Therefore, an AI (Artificial Intelligence) model, such as a Neural Network and Deep Learning, is introduced to these functions, and hence further sophistication is expected. For example, in the case in which an AI model is applied to object recognition processing that identifies the type of an obstacle (a person, an automobile, and any other object) from an image captured by a stereo camera, a series of the process procedures is considered in which objects (obstacles) are extracted by “structure estimation” based on parallax by stereo vision, the feature values of the obstacles are computed by CNN (Convolutional Neural Network) that is one kind of AI model from the image data of the extracted objects, and the types of obstacles corresponding to the feature values are identified. In this case, since the identification processes for types by CNN are performed for each obstacle extracted by the structure estimation process, when the number of extracted obstacles is increased, the load or time necessary to the CNN process is increased. In the automatic driving system, a series of processes for “operation” that perform driving control of a vehicle has to be executed real time. Therefore, even in the case in which an AI model is applied in order not to affect real time cycle processing for “operation”, the processes of “recognition”, “cognition”, and “determination” have to be completed within the deadline of cycle execution start for “operation”.

Patent Literature 1 describes that obstacles are detected from an image that captures the area in front of a host vehicle using a camera. A device described in this Patent Literature 1 highly accurately determines whether obstacles are pedestrians using a neural network that learns the motion patterns of actual pedestrians in the detection of obstacles as pedestrians.

### CITATION LIST

### Patent Literature

Patent Literature 1: Japanese Unexamined Patent Application Publication No. 2004-145660

### SUMMARY OF INVENTION

### Technical Problem

The technique described in Patent Literature 1 has a problem that processing time necessary to operation processing is increased in the case in which the number of objects, such as pedestrians, which are targets for the operation by the neural network.

### Solution to Problem

According to a first aspect of the present invention, preferably, a vehicle electronic controller includes a status acquiring unit configured to acquire status of a vehicle, and a determining unit configured to determine whether to configure an artificial intelligence model based on the status of the vehicle acquired at the status acquiring unit. When the determining unit determines that the artificial intelligence model is configured, an artificial intelligence model configured to execute a predetermined process is configured by combination of a plurality of operation units.

### Advantageous Effects of Invention

According to the present invention, processing time necessary to operation processing can be reduced corresponding to the status of a vehicle in which the number of objects is increased, for example.

### BRIEF DESCRIPTION OF DRAWINGS

FIG. 1 is a schematic block diagram of a neural network.

FIG. 2 is a block diagram of a vehicle electronic controller according to a first embodiment.

FIG. 3(a), FIG. 3(b), FIG. 3(c), FIG. 3(d), and FIG. 3(e) are status tables for use in AI model selection according to the first embodiment.

FIG. 4 is diagrams showing exemplary operation units configuring an AI model.

FIG. 5 diagrams showing AI models configured of operation units.

FIG. 6 is table information for use in reflecting AI model information on an accelerator.

FIG. 7 is a flowchart showing the process operation of the vehicle electronic controller according to the first embodiment.

FIG. 8 is a block diagram showing an exemplary modification of the configuration of the vehicle electronic controller according to the first embodiment.

FIG. 9 is a flowchart showing the process operation of the exemplary modification of the vehicle electronic controller according to the first embodiment.

FIG. 10 is a block diagram of a vehicle electronic controller according to a second embodiment.

FIG. 11(a), FIG. 11(b), and FIG. 11(c) are status tables for use in AI model selection according to the second embodiment.

FIG. 12 is a flowchart showing the process operation of the vehicle electronic controller according to the second embodiment.

FIG. 13 is a block diagram showing an exemplary modification of the configuration of the vehicle electronic controller according to the second embodiment.

FIG. 14 is table information for use in AI model selection according to an exemplary modification of the second embodiment.

FIG. 15 is a flowchart showing the process operation of the exemplary modification of the vehicle electronic controller according to the second embodiment.

FIG. 16 is a block diagram of a vehicle electronic controller according to a third embodiment.

FIG. 17 is a block diagram showing an exemplary modification of the configuration of the vehicle electronic controller according to the third embodiment.

### DESCRIPTION OF EMBODIMENTS

In the following, embodiments of the present invention will be described with reference to the drawings. Note that in the embodiments shown below, the same components and process content, for example, will be designated with the same number, and the description will be simplified. In the embodiments, a vehicle electronic controller equipped with an AI model (a prediction model) using artificial intelligence processing will be described, and an example of a Neural Network will be described for the AI model. However, the AI model may be a model relating to machine learning, Deep Learning, and reinforcement learning. The configurations of operation units are variable for combination, and hence the embodiments can be applied.

### First Embodiment

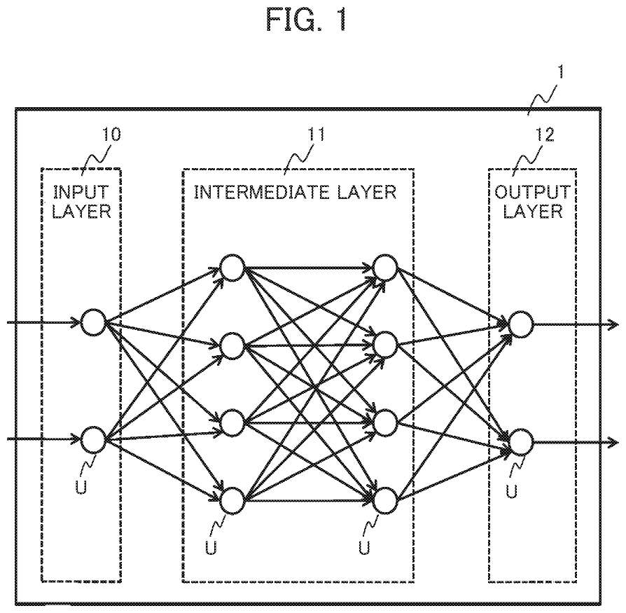

In the embodiment, an AI model is configured of a plurality of operation units, and the combination pattern of the operation units is uniquely selected, corresponding to the status of a vehicle electronic controller 20. In the following, the description will be described with reference to FIGS. 1 to 9. Note that the status of the vehicle electronic controller 20 means a host vehicle driving environment including the object number, driving scenes, weather, time slot, and device status, for example.

### <AI Model>

FIG. 1 is a diagram of an exemplary structure of an AI model.

As shown in FIG. 1, a neural network model 1 is configured of an input layer 10, an intermediate layer 11, and an output layer 12, and the layers have I operation units u, J operation units u, K operation units u, respectively. The operation units u are connected to each other based on joint information between the operation units u. Information inputted from the input layer 10 is propagated through the inside of the intermediate layer 11 according to the joint information, and information corresponding to the prediction result is finally outputted from the output layer 12. In the embodiment, joint information relating to the connection between the operation units u is described as “AI model structure information”. The joint information includes a coupling coefficient, and the information is propagated while operation using the coupling coefficient of the information as a parameter is performed. In the embodiment, the coupling coefficient used in AI model operation is described as “AI model parameter information”. The content of the operation is identified by the type of layer included in joint information. Examples of layers included in the joint information include a convolution layer, the batch normalization, activation function, pooling layer, fully connected layer, and LSTM (Long Short Term Memory) layer.

Note that the number of operation unit u and the number of layers configuring the intermediate layer 11 have no relation with the embodiments, and these numbers are given values. The structure of the AI model is also non-limiting, and may have recurrence or the bidirectional property to the connection between the operation units u. Any AI model, such as a machine learning model with or without teachers and a reinforcement learning model, is applicable in the viewpoint of selecting an AI model corresponding to the status of the vehicle electronic controller 20.

### <Configuration of the Vehicle Controller>

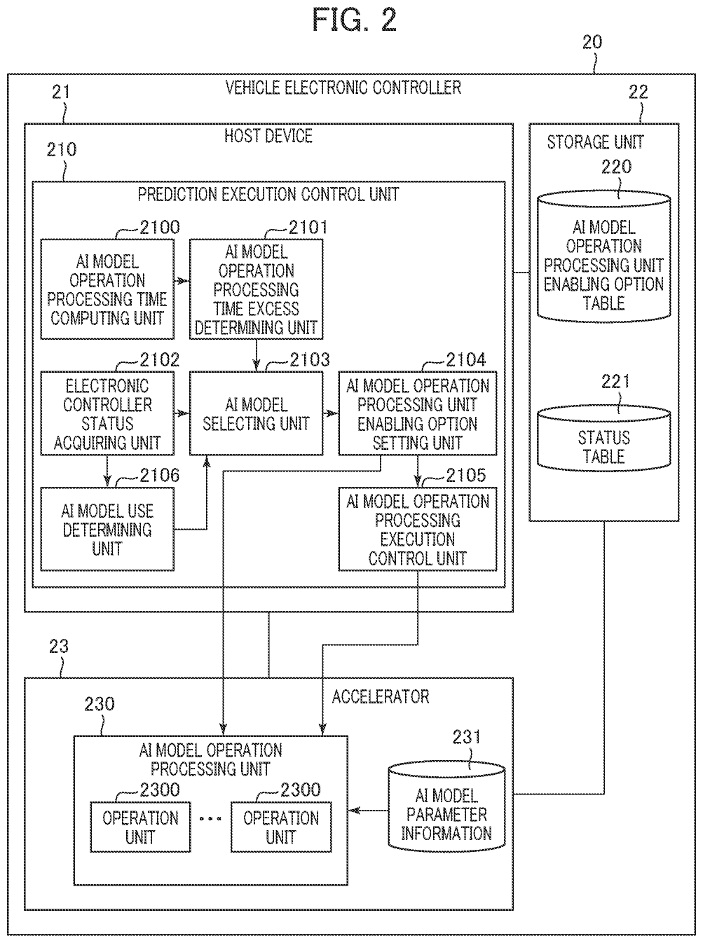

FIG. 2 is a block diagram of the vehicle electronic controller 20 according to the first embodiment. In the embodiment, the AI model is configured of a plurality of operation units 2300, and the combination pattern of the operation units 2300 is uniquely selected corresponding to the status of the vehicle electronic controller 20.

The vehicle electronic controller 20 is configured of a host device 21, a storage unit 22, and an accelerator 23. Note that the vehicle electronic controller 20 at least includes a CPU (Central Processing Unit), not shown, as hardware. The CPU controls the operation of the vehicle electronic controller 20 according to programs stored on the storage unit 22, and hence functions relating to the embodiment are implemented. However, the embodiment is not limited to such a configuration, and all or a part of the above-described functions may be configured as hardware.

The host device 21 includes a prediction execution control unit 210, and executes programs corresponding to the processes of the prediction execution control unit 210 by the CPU, and controls the accelerator 23 to implement functions relating to the embodiment. Note that all or a part of the processes of the prediction execution control unit 210 may be installed as hardware. A configuration may be provided in which the accelerator 23 includes a CPU and all or a part of the prediction execution control unit 210 is controlled by the accelerator 23.

The prediction execution control unit 210 is configured of a computing unit configured to compute operation processing time by an AI model (an AI model operation processing time computing unit) 2100, a determining unit configured to determine whether operation processing time by the AI model exceeds a predetermined time period (an AI model operation processing time excess determining unit) 2101, an acquiring unit configured to acquire the status of the electronic controller (an electronic controller status acquiring unit) 2102, a selecting unit 2103 configured to select an AI model, AI model operation processing unit enabling option setting unit 2104 configured to set enabling a unit used for AI model operation processing or disabling a unit not used, an AI model operation processing execution control unit 2105, and an AI model use determining unit 2106.

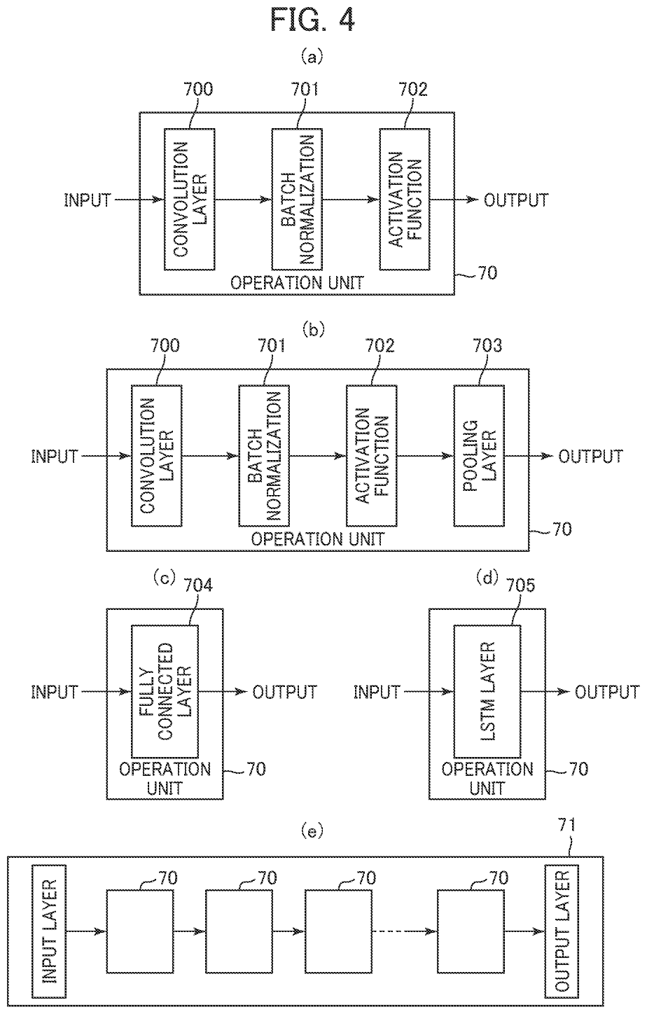

The AI model operation processing time computing unit 2100 computes the estimation of operation processing time by an AI model 71 shown in FIG. 4(e), described later. For estimation computing, the evaluation result of AI model operation processing determined in advance in the design stage of an AI model is used. At the point in time of completion of the design of the AI model, AI model structure information or AI model parameter information is uniquely determined. For operation processing, an exclusive accelerator is used. Therefore, the estimation of AI model operation processing time is possible. The AI model and the operation processing time for the AI model are stored on a processing time correspondence table (not shown in the drawing).

The AI model operation processing time excess determining unit 2101 determines whether application processing relating to automatic operation including AI model operation or driver assistance can be completed within a preset predetermined time period (until the deadline). The unit of application processing on which the deadline is provided is options. Examples of processing include processing from computing positional information on obstacles present in the surroundings of the host vehicle to sorting the types of obstacles and processing from computing positional information on obstacles and type information to predicting the behavior of the obstacles how the obstacles move in future.

The electronic controller status acquiring unit 2102 acquires information relating to the status of the vehicle electronic controller 20 necessary to select the combination pattern of operation units configuring an AI model for determining the AI model.

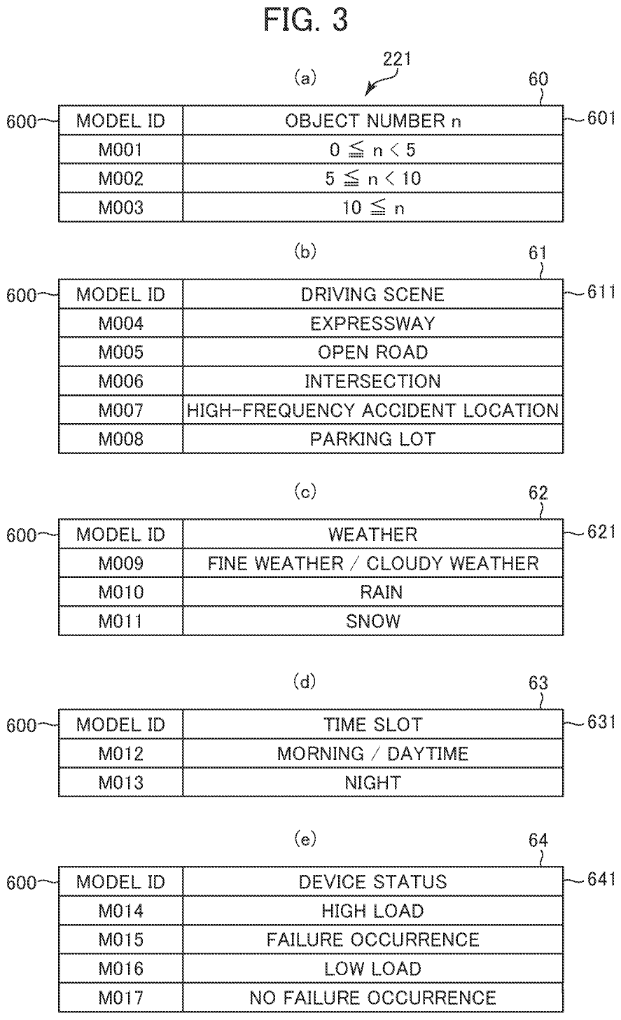

The AI model selecting unit 2103 identifies the combination pattern of the operation units of the AI model from information on the electronic controller status acquiring unit 2102 and determination result information of the AI model operation processing time excess determining unit 2101. From the combination pattern, reference is made to a status table 221 shown in FIG. 3, described later, and the AI model uniquely determined is selected.

Since the AI model operation processing unit enabling option setting unit 2104 uses the AI model selected at the AI model selecting unit 2103, the AI model operation processing unit enabling option setting unit 2104 sets the accelerator 23 for enabling the combination pattern of the operation units.

In order to execute AI model operation processing, the AI model operation processing execution control unit 2105 transfers input data necessary to AI model operation to the accelerator 23, and delivers a control instruction relating to operation execution start.

The AI model use determining unit 2106 receives the output result from the electronic controller status acquiring unit 2102, determines whether an AI model is used, and outputs the determination result to the AI model selecting unit 2103.

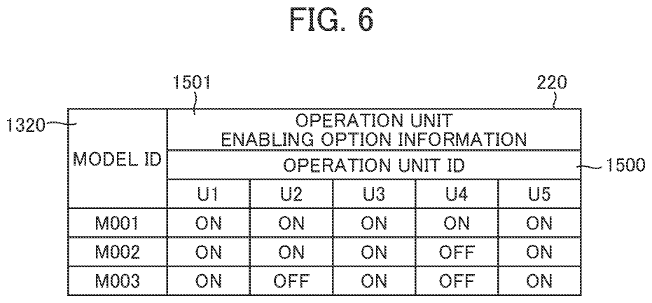

The storage unit 22 includes a status table 221 and an AI model operation processing unit enabling option table 220. The status table 221 holds information associating information relating to the status of the vehicle electronic controller 20 with the AI model. FIG. 3 shows an example of the table, and the detail will be described later. The AI model operation processing unit enabling option table 220 holds combination pattern information on the operation units 2300 of an AI model operation processing unit 230. The accelerator 23 is set based on combination pattern information. FIG. 6 shows an example of the table, and the detail will be described later.

The accelerator 23 includes hardware devices, such as an FPGA (Field-Programmable Gate Array), ASIC (Application Specific Integrated Circuit), and GPU (Graphics Processing Unit) configured to execute AI model operation processing at high speed. In the example shown in FIG. 2, the accelerator 23 includes an FPGA or ASIC, and the accelerator 23 is configured of the AI model operation processing unit 230 and AI model parameter information 231.

The AI model operation processing unit 230 executes AI model operation processing, and configured of one or more operation units 2300. The AI model parameter information 231 is parameter information for use in AI model operation processing, and indicates the coupling coefficient between the operation units u described in FIG. 1, for example. Note that the AI model parameter information 231 may be held in the inside or on the outside of the hardware device of the accelerator 23. In the case in which the AI model parameter information 231 on the outside of the device, the AI model parameter information 231 may be stored on the storage unit 22, or may be stored on another storage unit, not shown, connected to the accelerator 23.

Note that all or a part of AI model operation processing may be executed by the CPU, not by the accelerator 23. In the case in which a plurality of applications using different AI models is installed on the vehicle electronic controller 20, the AI model operation processing unit 230 may be provided by combination of the operation units 2300 corresponding to AI model structure information on a plurality of AI models or the AI model parameter information 231.

### <Status Table Used at the AI Model Selecting Unit>

FIG. 3 shows an example of the status table 221 associating information relating to the status of the vehicle electronic controller 20 with the AI model for management. The AI model selecting unit 2103 selects an AI model according to the status table 221. Information relating to the status of the vehicle electronic controller 20 is information indicating a host vehicle driving environment including the object number, driving scenes, weather, time slot, and device status, for example. This status table 221 is stored on the storage unit 22 shown in FIG. 2.

FIG. 3(a) is an object number-to-model ID correspondence table 60 that associates a model ID 600 with information on an object number 601. The model ID 600 is ID information that identifies an AI model uniquely determined by the combination pattern of the operation units. Here, FIG. 3(a) shows that there are three types of AI models determined by the combination pattern of the operation units. However, the number of types of AI models is options, and one type or more may be fine. Instead of AI models, models based on the rules in manual logic design with no use of AI.

The object number 601 shown in FIG. 3(a) indicates the number of objects (obstacles), which are detected by external sensing, in the surroundings of the host vehicle. With the use of the AI model, the types of detected objects, such as vehicles, bicycles, and pedestrians, are identified, or the behaviors of detected objects are predicted, how the objects move in future.

Note that in the objects detected by external sensing, the number of objects targeted for AI model operation may be fine, not the number of objects detected by external sensing. This intends not to include objects, such as obstacles on the opposite lane, which are clearly irrelevant to the drive track plan of the host vehicle.

In the combination of the object number and the AI model shown in FIG. 3(a), in the case in which the object number n is 10≤n, for example, i.e., in the case in which the number of times of repeatedly executing AI model operation processing, in order to suppress processing time necessary to AI model operation, ID=M003 that is an AI model having a short processing time is used, although operation accuracy is slightly degraded. In the case in which the object number n is 0≤n<5, ID=M001 that is an AI model having a long processing time and high operation accuracy, compared with ID=M003, is used. In the case in which the object number n is 5≤n<10, ID=M002 in the middle is used. The combination of the object number and the AI model shown in FIG. 3(a) is an example, but not limited to this.

FIG. 3(b) is a driving scene-to-model ID correspondence table 61 associating the model ID 600 with information on a driving scene 611. The model ID 600 is ID information that identifies an AI model uniquely determined by the combination pattern of the operation units.

The driving scene 611 shown in FIG. 3(b) shows information relating to the driving lane of the host vehicle. Examples of this information include an expressway, open road, intersection, high-frequency accident location, and parking lot, and an AI model is selected based on these pieces of information. For example, an example is considered in which when the processing period of actuator control involved in driving is the same between the expressway and the open road, the breakdowns of processing time for automatic operation logic are changed. Since the drive track generation processing of the host vehicle in open road driving meets more complicated driving lanes, compared with expressways, processing time is greatly reserved, compared with in expressway driving. In this case, although in open road driving, the operation accuracy of object recognition using AI models or the behavior prediction of objects is slightly degraded, compared with expressway driving, processing time has to be decreased. Therefore, in open road driving, M005 that is an AI model having a short processing time, compared with in expressway driving, is selected, whereas in expressway driving, M004 that is an AI model having high operation accuracy and a long processing time, compared with in open road driving, is selected. At the intersection, M006 that is an AI model having a shorter processing time than in the open road is selected. At the high-frequency accident location, M007 that is an AI model having a slightly shorter processing time than in the open road is selected. In the parking lot, M008 that is an AI model having a longer processing time than in the expressway is selected.

Note that the combination of the driving scene and the AI model shown in FIG. 3(b) is an example, but not limited to this. The AI model is not necessarily switched corresponding to all the driving scenes shown in FIG. 3(b). The AI model may be switched for every some driving scenes from the driving scenes shown in FIG. 3(b), or the AI model may be switched corresponding to the combination of driving scenes including driving scenes not shown in FIG. 3(b).

The driving lane information is identified by map matching with geographic information based on host vehicle positional information, or using the traffic infrastructure or information transmitted from telematics centers.

FIG. 3(c) is a weather-to-model ID correspondence table 62 associating the model ID 600 with information on a weather 621. The model ID 600 is ID information that identifies an AI model uniquely determined by the combination pattern of the operation units.

The weather 621 shown in FIG. 3(c) indicates information relating to weathers at the driving point of the host vehicle, and weather types, such as fine weather, cloudy weather, rain, and snow, are considered. For example, in the case in which the weather is not good, such as rain or snow, it is assumed that the accuracy of external sensing is reduced, compared with the weather is good, and design is made as below. That is, design is made such that degraded processing time is decreased, although the operation accuracy of object recognition using AI models or the behavior prediction of objects is slightly degraded. Thus, the cycle of feedback to the application using diagnosis relating to the validity of the output result of AI model operation the AI model of the diagnostic result is shortened. Therefore, in the case in which the weather is good, such as fine weather or cloudy weather, M009 that is an AI model having a long processing time, compared with raining or snowing, is used. In the case in which the weather is not good, such as rain, M010 that is an AI model having a short processing time, compared with fine weather or cloudy weather is used. In the case in which the weather is not good, such as snow, M011 that is an AI model having a short processing time, compared with fine weather or cloudy weather is used. Note that the combination pattern of types of weather information and the AI model is an example, but not limited to this. The weather information is determined using results from camera images, wiper operating information, rain/snow sensor information, and sensing result information on another vehicle, for example.

FIG. 3(d) is a time slot-to-model ID correspondence table 63 associating the model ID 600 with information on a time slot 631. The model ID 600 is ID information that identifies an AI model uniquely determined by the combination pattern of the operation units.

The time slot 631 shown in FIG. 3(d) indicates information relating to the time slot in which the host vehicle is driving, and the types of morning/daytime and night are considered. For example, in the case of night, it is assumed that the accuracy of external sensing is reduced, compared with in the morning and in the daytime, and the cycle of feedback to the application using diagnosis relating to the validity of the output result of AI model operation the AI model of the diagnostic result is shortened. Therefore, design is made such that processing time is decreased, although the operation accuracy of object recognition using AI models or the behavior prediction of objects is slightly degraded. Therefore, in the case in which the driving time slot is daytime, M012 that is an AI model having a long processing time, compared with nighttime is used. In the case of nighttime, M013 that is an AI model having a short processing time, compared with daytime is used. Note that the combination pattern of the types of time slots and the AI model, but not limited to this. The time slot information is detected using illuminance sensor information and GPS time information, for example.

FIG. 3(e) is a device status-to-model ID correspondence table 64 associating the model ID 600 with information on device status 641. The model ID 600 is ID information that identifies an AI model uniquely determined by the combination pattern of the operation units.

The device status 641 shown in FIG. 3(e) indicates information relating to the device status of hardware and software of the vehicle electronic controller 20, and includes the types of the presence or absence of failure occurrence in the vehicle electronic controller 20 and the load status of the CPU or the accelerator. For example, in the case in which a failure occurs in the vehicle electronic controller 20 or in the case of a high load, M014 or M015 that is an AI model lightweight and having a short processing time, instead of M016 or M017 that is an AI model usually used, although operation accuracy is slightly degraded. Note that the combination pattern of the types of the device status and the AI model is an example, but not limited to this.

Note that although not shown in the drawing, a configuration may be provided in which all or some of the object number 601 shown in FIG. 3(a) to FIG. 3(e), the driving scene 611, the weather 621, the time slot 631, the information on the device status 641 are combined to generate a table associating these pieces of information with the AI models, and an AI model may be selected corresponding to the combination of these pieces of information. Furthermore, the combination is not necessarily the combination of AI models, and the combination may be the combination of models based on the rules in manual logic design with no use of AI and AI models.

### <Operation Units Configuring the AI Model>

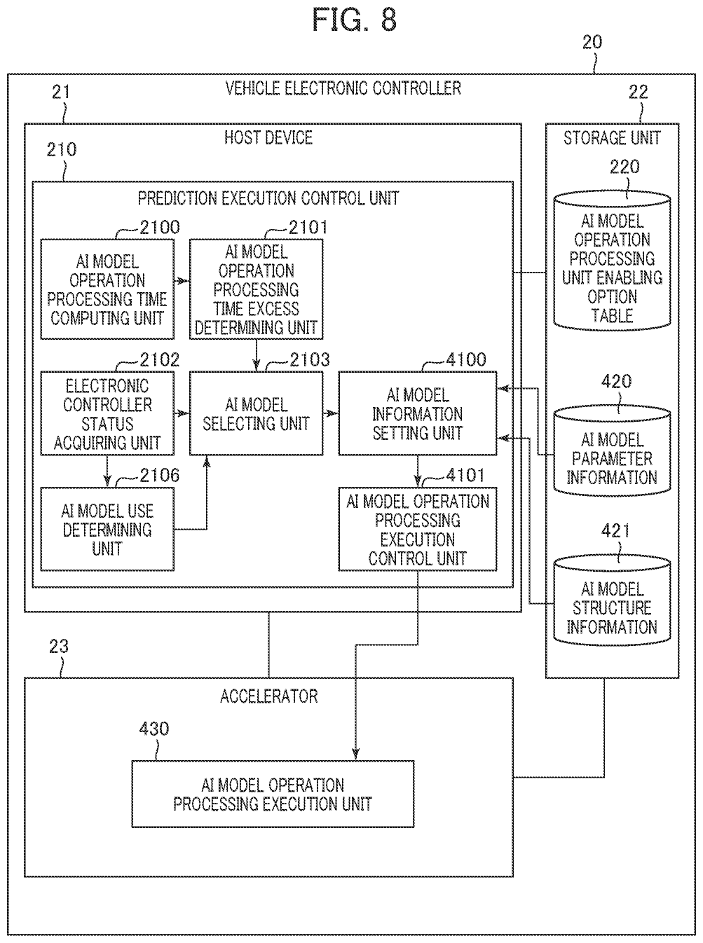

FIG. 4 is diagrams showing examples of operation units 70 configuring the AI model. Note that the operation unit 70 is mounted on the AI model operation processing unit 230 shown in FIG. 2, or stored on an AI model structure information 421, described later, shown in FIG. 8.

FIG. 4(a) is an exemplary operation unit 70 configured of a convolution layer 700, a batch normalization 701, and an activation function 702. FIG. 4(b) is an exemplary operation unit 70 configured of the convolution layer 700, the batch normalization 701, the activation function 702, and a pooling layer 703. FIG. 4(c) is an exemplary operation unit 70 configured of the fully connected layer 704. FIG. 4(d) is an exemplary operation unit 70 configured of an LSTM layer 705.

As shown in FIG. 4(e), in an AI model 71, the intermediate layer is configured of one or more operation units 70. The number of the operation unit 70 is options, and the combination pattern of the types of the operation units 70 is also free. For example, the AI model 71 may be configured of combination of ten operation units 70 in FIG. 4(b), or the AI model 71 may be configured of combination of pluralities of operation units 70 in FIG. 4(a), FIG. 4(b), and FIG. 4(c). Note that the AI model 71 may be configured of combination of operation units 70 other than ones shown in FIG. 4.

### <Exemplary Configuration of the AI Models Configured of the Operation Units>

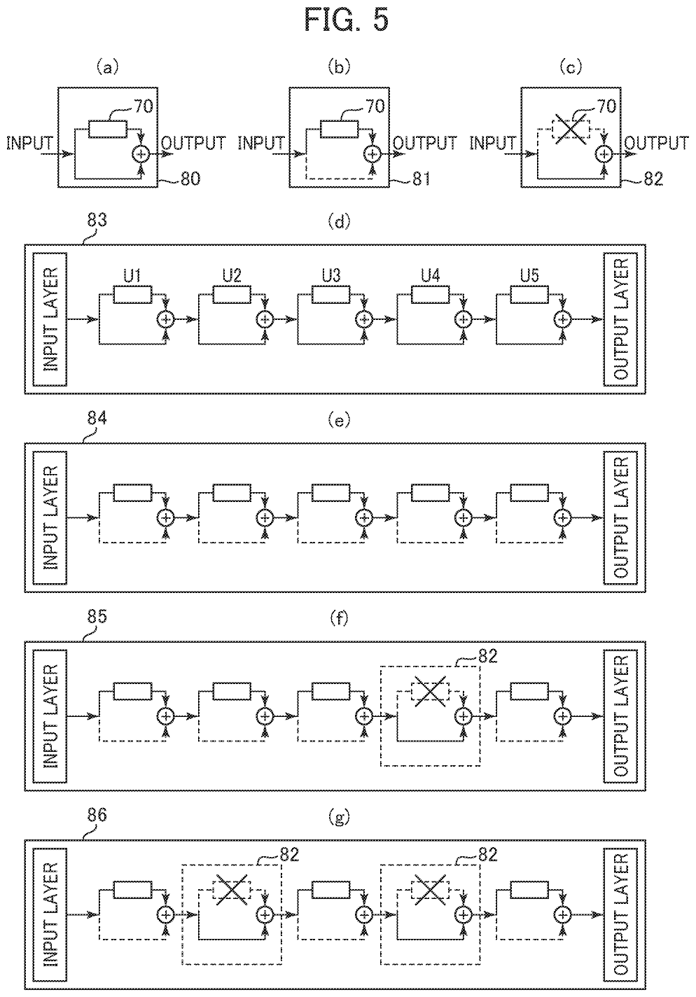

FIG. 5 is diagrams showing AI models configured of the operation units 70. FIG. 5(a) shows an example of a switching function-equipped operation unit (an enabling/disabling switching function-equipped operation unit) 80 configured to whether the operation unit 70 is enabled or disabled. Such an operation unit 80 can switch the operation unit 70 by enabling or disabling the processing of the operation unit 70. FIG. 5(b) shows the case in which the processing of the operation unit 70 is enabled. FIG. 5(c) shows the case in which the processing of the operation unit 70 is disabled. FIG. 5(d) shows the enabling/disabling switching function-equipped AI model 83 configured of the combination of one or more enabling/disabling switching function-equipped operation units 80 as the intermediate layer. Here, an example is used in which five operation units 80 are combined, but the number of combinations is options.

FIG. 5(e) is a diagram showing an AI model 84 in the case in which the processing of the operation unit 70 is all enabled in the enabling/disabling switching function-equipped AI model 83. FIG. 5(f) is a diagram showing an AI model 85 in the case in which the processing of the fourth operation unit 70 from the left is disabled alone, and other operation units 70 are all enabled in the enabling/disabling switching function-equipped AI model 83. FIG. 5(g) is a diagram showing an AI model 86 in the case in which the processing of the second operation unit 70 and the fourth operation unit 70 from the left is disabled, and the other operation units 70 are all enabled in the enabling/disabling switching function-equipped AI model 83.

The AI model 85 shown in FIG. 5(f) does not execute the processing of a part of the operation units, and hence processing time can be shortened, compared with the AI model 84 shown in FIG. 5(e). The AI model 86 shown in FIG. 5(g) has the similar reasons, and hence processing time can be shortened, compared with the AI model 84 shown in FIG. 5(e) or the AI model 85 shown in FIG. 5(f).

These AI models are properly used corresponding to the status of the vehicle electronic controller 20 shown in FIG. 3, and hence processing can be completed within a predetermined time period (within the deadline) for desired processing completion corresponding to the status of the vehicle electronic controller 20. For example, in the case in which the object number is large, the AI model 86 shown in FIG. 5(g) is used. Note that in the case in which the AI model according to the embodiment is mounted as an exclusive circuit, the enabling/disabling switching function-equipped AI model 83 shown in FIG. 5(d) only has to be installed, and the AI model 84, the AI model 85, and the AI model 86 can be implemented by changing only the settings of switches between enabling and disabling. Thus, an increase in the hardware resources for generating an exclusive circuit can be suppressed, compared with the case in which a plurality of the AI models whose types are completely different is mounted.

FIG. 6 is table information for use in reflecting AI model information on the accelerator. This table information is stored on the AI model operation processing unit enabling option table 220 shown in FIG. 2. Based on this table information, an enabling/disabling switch is set to the enabling/disabling switching function-equipped AI model 83 shown in FIG. 5(d). The table information shown in FIG. 6 is an example.

The AI model operation unit enabling option table 220 shown in FIG. 6 is table information associating identification information on the AI model shown in a model ID 1320 with enabling/disabling information for each operation unit shown in operation unit enabling option information 1501 for management.

The AI model 84 shown in FIG. 5(e) has settings corresponding to the model ID=M001 shown in FIG. 6, and U1 to U5 that are all the operation units ID are turned “ON”, in order to enable all the operation units.

The AI model 85 shown in FIG. 5(f) has settings of the model ID=M002 shown in FIG. 6, and the operation unit ID U4 alone is turned “OFF”, and the operation units ID except that are turned “ON”, in order to disable the fourth operation unit from the left.

The AI model 86 shown in FIG. 5(g) has settings of the model ID=M003 shown in FIG. 6, the operation unit IDs U2 and U4 are turned “OFF”, and the operation unit ID except these are turned “ON”, in order to disable the second operation unit and the fourth operation unit from the left.

In the table information shown in FIG. 6, three model IDs are shown as examples. However, a plurality of pieces of operation unit enabling option information 1501 is stored on the table information corresponding to the model ID=M001 to the model ID=M017 shown in FIG. 3. Reference is made to the corresponding model ID shown in FIG. 6 from the model ID shown in FIG. 3 selected based on the number of objects, for example, and the enabling or disabling of the operation unit is set.

### <Operation of the Vehicle Electronic Controller>

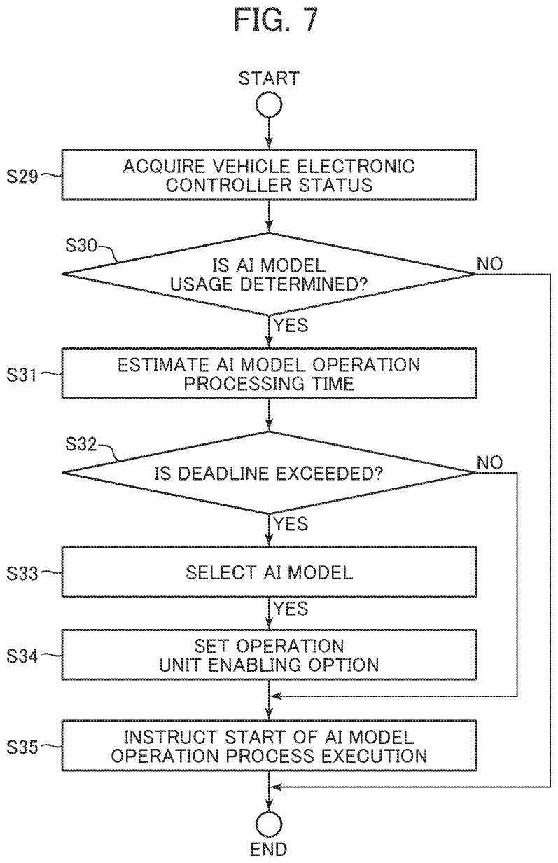

FIG. 7 is a flowchart showing the process operation of the vehicle electronic controller 20 according to the embodiment. The present flow is started in the execution of operation processing by the AI model.

The process transitions to Step S29. The electronic controller status acquiring unit 2102 acquires information relating to the status of the vehicle electronic controller 20 necessary to determine an AI model. An example of information relating to the status of this vehicle electronic controller 20 is as described with reference to FIG. 3. After that, the process transitions to Step S30. The AI model use determining unit 2106 determines whether an AI model is used based on information relating to the status of the vehicle electronic controller 20. In the case in which it is determined that the AI model is used in Step S30, the process flow is ended, and a process using a rule-based model is executed. On the other hand, in the case in which it is determined that the AI model is used in Step S30, the process transitions to Step S31.

In Step S31, the AI model operation processing time computing unit 2100 estimates time necessary to AI model operation processing. The AI model and the operation processing time for the AI model are stored on the processing time correspondence table. The AI model operation processing time computing unit 2100 determines the result, in which operation processing time is multiplied by the number of times of processing corresponding to the number of objects, for example, as AI model operation processing time.

After that, the process transitions to Step S32. The AI model operation processing time excess determining unit 2101 determines whether application processing including AI model operation exceeds a predetermined time period for completion of preset processing (in the following, a deadline). Deadlines different for driving scenes, such as expressways and open roads, may be set. In addition to this, deadlines may be varied corresponding to the status of the vehicle electronic controller 20.

In the case in which it is determined that the deadline is not exceeded in Step S32, the process transitions to Step S35. In this case, the AI model set in default is to be selected, not selecting the type of the AI model uniquely determined by the combination pattern of the operation units of the AI model. In the case in which it is determined that the deadline is exceeded in Step S32, the process transitions to Step S33. The AI model selecting unit 2103 selects the type of the AI model uniquely determined by the combination pattern of the operation units of the AI model from information relating to the status of the vehicle electronic controller 20 acquired by the electronic controller status acquiring unit 2102 and the determination result of the AI model operation processing time excess determining unit 2101. Specifically, the AI model selecting unit 2103 reads the model ID corresponding to information relating to the status of the vehicle electronic controller 20 from the status table shown in FIG. 3, makes reference to the AI model operation processing unit enabling option table 220 shown in FIG. 6 based on the read model ID, and selects operation processing unit enabling option information. In the following, this process is described as “AI model selection”. In this case, operation processing unit enabling option information is selected such that a predetermined process is completed in a predetermined time period.

In Step S34, the AI model operation processing unit enabling option setting unit 2104 sets the combination pattern of the operation units to the accelerator 23 according to information on the AI model operation processing unit enabling option table 220 stored on the storage unit 22.

After that, the process transitions to Step S35. The AI model operation processing execution control unit 2105 transfers input data necessary to AI model operation to the accelerator 23, delivers a control instruction relating to operation execution start, and hence executes AI model operation processing. In this operation process, an AI model having a short processing time although operation accuracy is slightly degraded or an AI model having a long processing time and high operation accuracy is selected corresponding to the number of objects, for example, and hence a predetermined process is completed in a predetermined time period.

Note that an AI model maybe selected using information relating to the status of the vehicle electronic controller 20 alone, with the omission of the processes in Steps S30 and S31. This is effective to the case in which the status of the vehicle electronic controller 20 is not dynamically changed each time in the unit of processing AI model operation. In this case, the processes in Steps S30 and S31 are unnecessary.

### <Exemplary Modification of the Vehicle Controller>

FIG. 8 is a block diagram showing an exemplary modification of the configuration of the vehicle electronic controller 20 according to the first embodiment shown in FIG. 2. The accelerator 23 shown in FIG. 2 includes a GPU, and hence the prediction execution control unit 210, the storage unit 22, and a part of the accelerator 23 are changed.

In FIG. 8, in the prediction execution control unit 210, shown in FIG. 2 the AI model operation processing unit enabling option setting unit 2104 is removed, and an AI model information setting unit 4100 is included, instead. The AI model operation processing execution control unit 2105 is removed, and an AI model operation processing execution control unit 4101 is included instead.

The AI model information setting unit 4100 reads AI model parameter information 420 matched with information on the AI model selected at the AI model selecting unit 2103 and the AI model structure information 421 from the storage unit 22, and stores the pieces of information on a memory (RAM: Random Access Memory) that the CPU uses in the execution of programs.

The AI model operation processing execution control unit 4101 transfers the AI model parameter information 420 and the AI model structure information 421 expanded on the memory and input data targeted for AI model operation processing to the accelerator 23, and delivers the control instruction involved in operation execution start.

The storage unit 22 newly stores the AI model parameter information 420 and the AI model structure information 421. The content of the AI model parameter information and the content of the AI model structure information are as described above.

The accelerator 23 has a configuration in which the AI model parameter information 231 shown in FIG. 2 is removed. In this configuration, the accelerator 23 does not keep holding AI model parameter information, and AI model parameter information is transferred to the accelerator 23 for every AI model operation process execution. However, a configuration may be provided in which the accelerator 23 keeps holding this information.

The AI model operation processing unit 230 shown in FIG. 2 is removed, and an AI model operation processing execution unit 430 is added instead. Unlike the AI model operation processing unit 230, the AI model operation processing execution unit 430 is not configured of the exclusive circuit specialized to the AI model installed on the vehicle electronic controller 20, i.e., a plurality of operation units 2300, and the AI model operation processing execution unit 430 is configured in which a plurality of general-purpose computing units that can execute various AI models involved in the operation at high speed is installed. However, the execution of operation processing corresponding to the plurality of operation units 2300 is possible, and hence the same AI model operation processing can be executed between the AI model operation processing unit 230 and the AI model operation processing execution unit 430.

### <Operation of the Exemplary Modification of the Vehicle Electronic Controller>

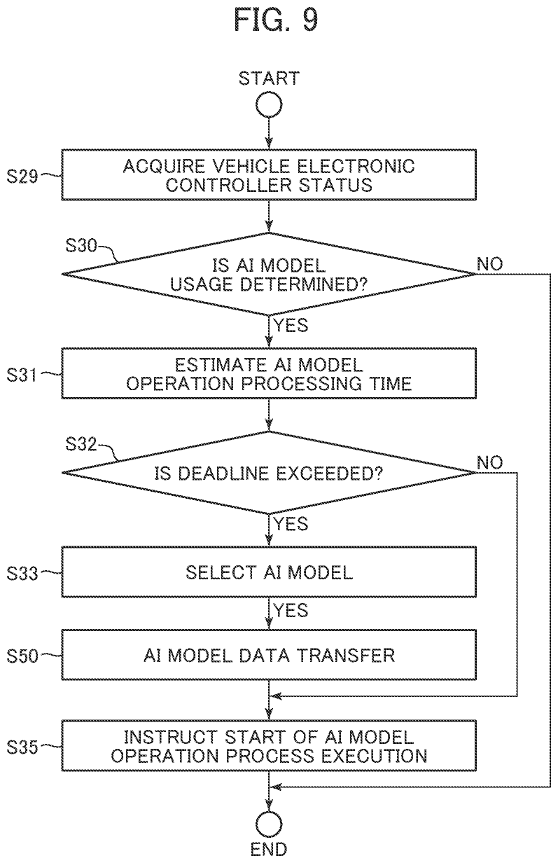

FIG. 9 is a flowchart showing the process operation of the exemplary modification (FIG. 8) of the vehicle electronic controller 20 according to the first embodiment.

Compared with the processes described in FIG. 7, in the flowchart of FIG. 9, Step S34 is removed, and Step S50 is added instead. In Step S50, after an AI model is selected in Step S33, the AI model operation processing execution control unit 4101 transfers the AI model parameter information and the AI model structure information expanded on the memory by the AI model information setting unit 4100 to the AI model operation processing execution unit 430 of the accelerator 23. After that, the process transitions to Step S35, input data targeted for AI model operation processing is transferred to deliver the control instruction involved in operation execution start, and hence AI model operation processing is executed.

According to the first embodiment, AI model operation processing including a neural network is completed within a desired time period, and can be implemented with the suppression of an increase in the consumption of the hardware resources of a hardware accelerator that executes AI model operation processing as much as possible.

### Second Embodiment

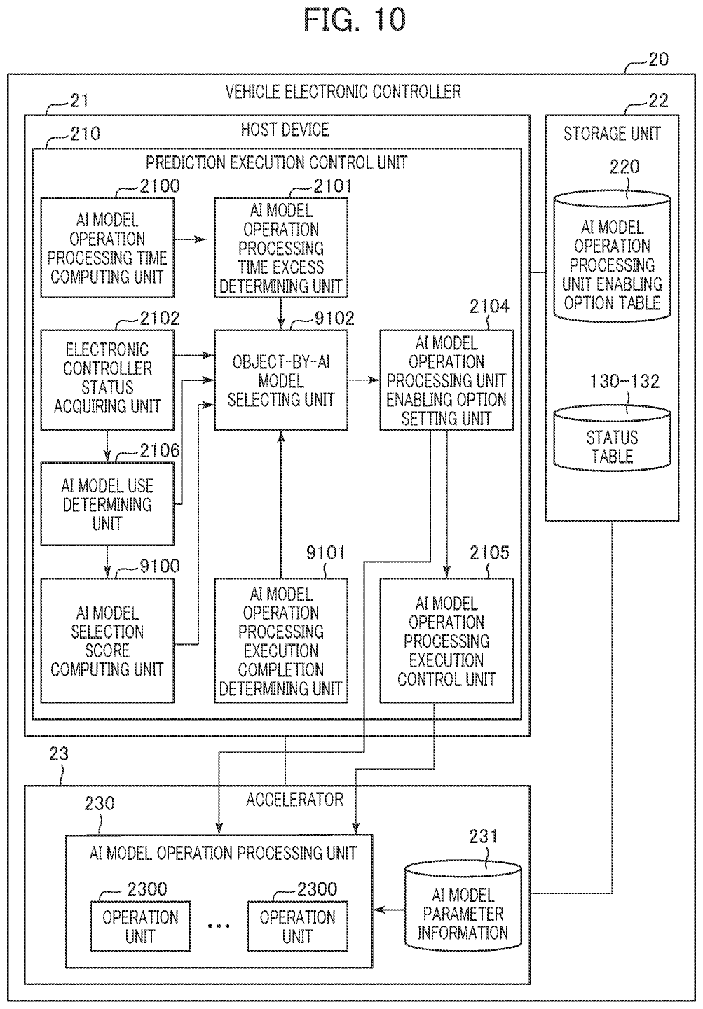

In the second embodiment, an AI model is selected for each input data targeted for AI model operation processing corresponding to the status of the vehicle electronic controller 20. In the following, the second embodiment will be described with reference to FIG. 10 to FIG. 15. Note that the schematic block diagram of the neural network shown in FIG. 1, the block diagram of the AI model shown in FIG. 4, the block diagram of the operation units configuring the AI model shown in FIG. 5, and table information for use in reflecting AI model information on the accelerator shown in FIG. 6 are also the same in the embodiment, and the description is omitted.

The embodiment is applied to the case in which to a plurality of objects (obstacles) detected by external sensing, for example, the pieces of object data is individually inputted to the AI model and the types of objects (vehicles, people, and bicycles, for example) are determined, or to the case in which the behaviors of objects in future (positions after the objects move and positional information, for example) are predicted. When the pieces of object data are individually inputted to AI models for operation, an AI model is selected for each object data.

### <Configuration of the Vehicle Controller>

FIG. 10 is a block diagram of a vehicle electronic controller 20 according to the second embodiment. In the configuration shown in FIG. 10, an AI model selection score computing unit 9100, an AI model operation processing execution completion determining unit 9101, and an object-by-AI model selecting unit 9102 are newly added to a prediction execution control unit 210, and the AI model selecting unit 2103 is removed, compared with the configuration of the first embodiment shown in FIG. 2. The configuration of the vehicle electronic controller 20 according to the embodiment includes an FPGA or ASIC in an accelerator 23.

The AI model selection score computing unit 9100 computes a score value that selects an AI model for each input data targeted for AI model operation processing (e.g. an externally sensed object in the surroundings of host vehicle data). For computing the score value, not only input data targeted for AI model operation processing but also all the externally sensed objects, which are not finally targeted for operation processing in the surroundings of the host vehicle may be targeted.

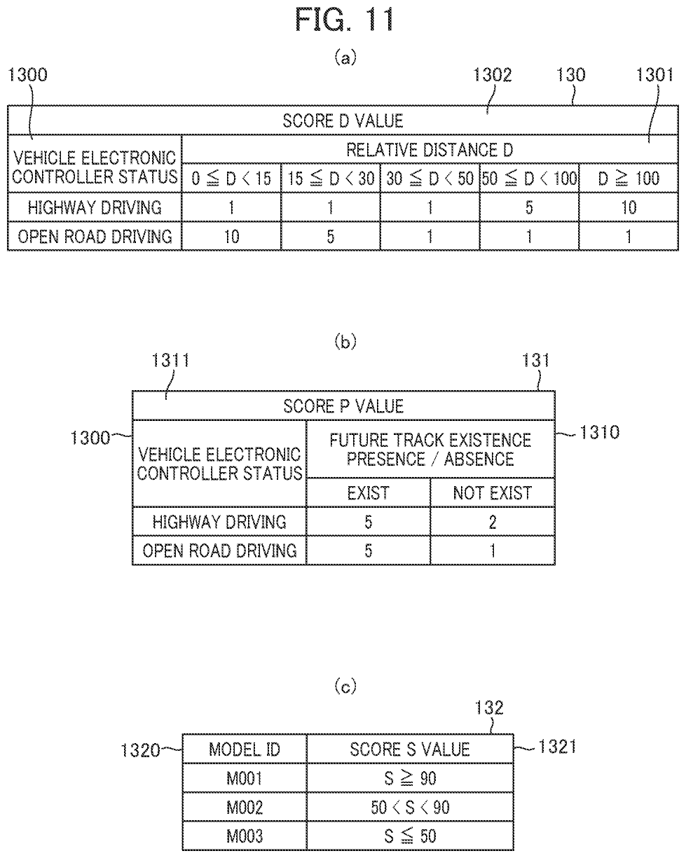

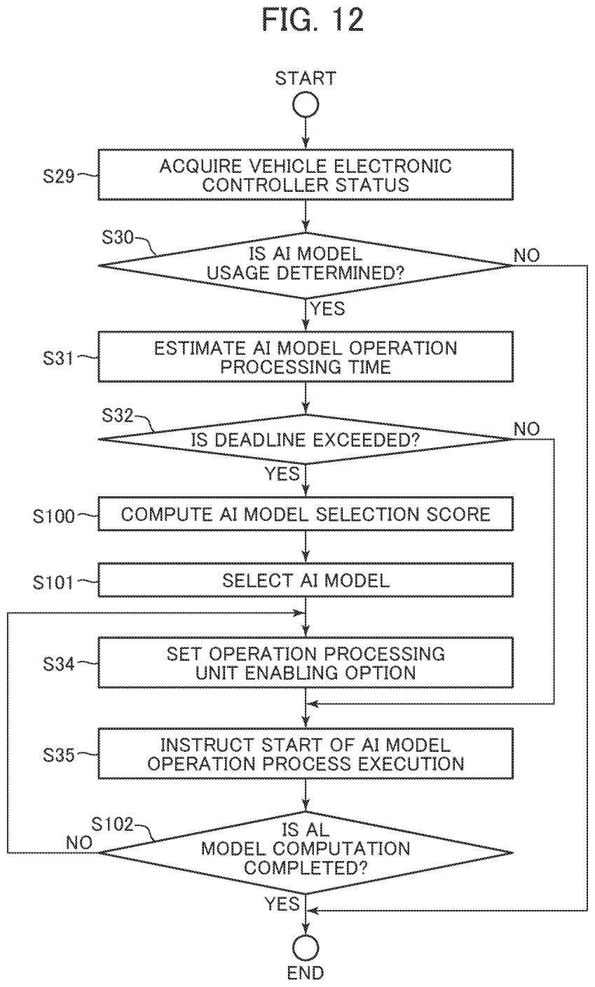

The AI model operation processing execution completion determining unit 9101 determines whether AI model operation processing is completed for all the pieces of input data targeted for AI model operation processing. Note that specific examples of score value computing and AI model selection will be described later using FIG. 11 and FIG. 12.

The object-by-AI model selecting unit 9102 selects an AI model used for operation processing based on the score value for each input data targeted for AI model operation processing, the score value being computed at the AI model selection score computing unit 9100.

### <Status Table for Use in AI Model Selection>

FIGS. 11(a), 11(b), and 11(c) are status tables 130 to 132 according to the second embodiment for use in AI model selection. These status tables 130 to 132 are stored on a storage unit 22, and store table information used at the AI model selection score computing unit 9100 and the object-by-AI model selecting unit 9102.

The AI model selection score computing unit 9100 and the object-by-AI model selecting unit 9102 compute score values for objects (obstacles), which are detected by external sensing, in the surroundings of the host vehicle. Thus, the combination of the operation units used for each object, i.e., an AI model is selected. The table information is used for this purpose.

FIG. 11(a) is the score D value table 130 that computes a score value from the relative distance between the detected object and the host vehicle. The score value is managed such that the score value can be a different value suitable for the driving scene. The score D value table 130 stores a vehicle electronic controller status 1300, a relative distance D1301, and a score D value 1302 in association with each other.

The vehicle electronic controller status 1300 on the score D value table 130 expresses a driving scene in the embodiment, and expresses score values corresponding to expressway driving and open road driving. The relative distance D1301 is the score value managed by the value of the relative distance between the detected object and the host vehicle. In the embodiment, the score value is managed by the ranges of five types of relative distance values. Note that as another example except the relative distance that manages the score value, the score value may be managed by the relative velocity between the detected object and the host vehicle or by Time To Collision (TTC). As another example of the vehicle electronic controller status 1300, the score value may be managed corresponding to the information, such as the driving scene 611, the weather 621, the time slot 631, and the device status 641, described in FIG. 3.

The score D value 1302 is the score value that is allocated corresponding to the value of the relative distance between the object and the host vehicle. This score value is set as the design value of the score D value table 130 by the user in advance.

FIG. 11(b) shows the table that computes the score value using information whether the detected object is present on the track of the driving plan of the host vehicle. The score P value table 131 is a table that manages the vehicle electronic controller status 1300, future track existence presence/absence information 1310, and a score P value 1311 in association with each other.

The vehicle electronic controller status 1300 on the score P value table 131 expresses a driving scene in the embodiment, and expresses score values corresponding to expressway driving and open road driving. The future track existence presence/absence information 1310 is the score value managed by whether the detected object is present on the track of the driving plan of the host vehicle. The case in which the presence of the detected object on the track is “EXIST”, whereas the case in which the absence of the detected object on the track is “NOT EXIST”. The score P value 1311 is the score value that is allocated corresponding to the information whether the detected object is present on the track of the driving plan of the vehicle. This score value is set in the design of the score P value table 131 by the user in advance.

FIG. 11(c) shows a table that selects an AI model corresponding to a score S value computed from the values of the score D value 1302 and the score P value 1311. The score S value table 132 is a table that manages model IDs 1320 and score S values 1321 in association with each other.

The model ID 1320 on the score S value table 132 is ID information that identifies an AI model expressed by the combination pattern of the operation units. The score S value 1321 is computed from the values of the score D value 1302 and the score P value 1311, and is the score value used for AI model selection.

A computing method for the score S value is set by the user in advance in the design of the score S value table 132, and is computed by an evaluation formula, such as score S value=W1* score D value+W2*score P value, for example. Here, W1 and W2 are given constant values. In the design stage of the application using AI models, the value range of the score S value possibly taken is determined for each model, and the score S value table 132 is generated. W1 and W2 may be individually set corresponding to the vehicle electronic controller status 1300.

In the example of the score S value table 132 shown in FIG. 11(c), in the case in which the host vehicle is driving on the expressway, the relative distance to the host vehicle is large, the score S value 132 becomes large to the object present on the track of the driving plan, whereas in the case in which the host vehicle is driving on the open road, the relative distance to the host vehicle is small, and the score S value 132 becomes large to the object present on the track of the driving plan. This is an example of the score value table generated in which in the case of expressway driving, a highly accurate AI model having a long processing time is allocated in priority to an object more away from the host vehicle, whereas in the case of open road driving, a highly accurate AI model having a long processing time is allocated in priority to an object closet to the host vehicle. In the case of expressway driving, the type of object is limited to vehicles or two-wheel vehicles, and the driving course is relatively simple such that the host vehicle travels straight on the white line drawn on the road, compared with open road driving. Thus, to the object closer to the host vehicle, a simple AI model having a short processing time or a rule-based model is allocated. On the other hand, in the case of open road driving, the types of objects are diverse including pedestrians (children and elderly people), bicycles, and obstacles temporarily placed, for example, in addition to vehicles or two-wheel vehicles, and driving courses include right and left turns and roads with no white lines in infinite places, compared with in expressway driving. Thus, even to the object closer to the host vehicle, a highly accurate AI model having a long processing time is allocated for safety. As described above, based on the relative relationship between the host vehicle and the object, the priority level is imparted to the object, and a plurality of configurations of the operation unit is selected corresponding to the priority level of the object.

Note that the model ID 1320 is not necessarily AI models entirely. Models based on the rules in manual logic design with no use of AI may be fine. That is, the model that can be selected by the score value may be AI-based models or may be rule-based models whose logic is manually designed.

### <Operation of the Vehicle Electronic Controller>

FIG. 12 is a flowchart showing the process operation of the vehicle electronic controller 20 according to the second embodiment. The same portions as the flowchart according to the first embodiment shown in FIG. 7 are designated with the same reference signs, and the description is simplified.

After the end of Step S32 shown in FIG. 12, the process transitions to Step S100. The AI model selection score computing unit 9100 computes a score value that selects an AI model for each object to all the objects targeted for AI model operation processing, or to all the sensed objects in the surroundings of the host vehicle.

The process transitions to Step S101. The object-by-AI model selecting unit 9102 selects an AI model the combination pattern of the operation units of the AI model for each object, i.e., the AI model based on the score value for each object computed in Step S100. After that, through Steps S34 and S35, the process transitions to Step S102.

In Step S102, in the case in which the AI model operation processing execution completion determining unit 9101 determines that AI model operation processing is completed to all the objects, the process flow is ended. In Step S102, in the case in which the AI model operation processing execution completion determining unit 9101 determines that AI model operation processing is not completed to all the objects, the process transitions to Step S34. The accelerator 23 is set being matched with the AI model selected for each object, AI model operation processing is executed, and the processes are repeatedly executed until the determination in Step S102 is Yes.

### <Exemplary Modification of the Vehicle Controller>

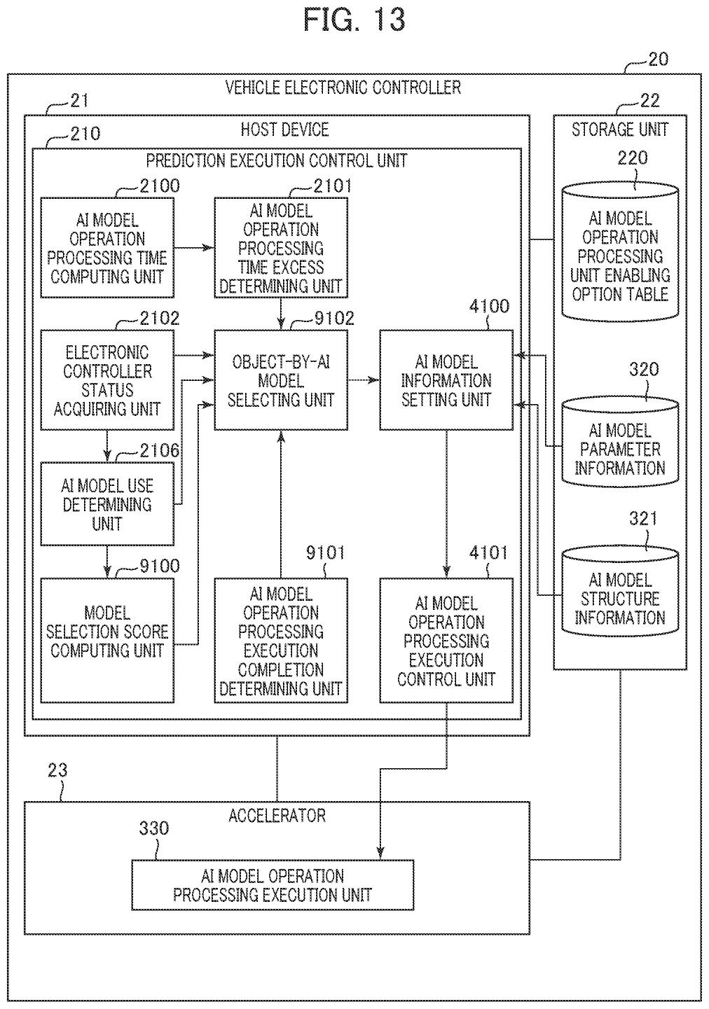

FIG. 13 is a block diagram showing an exemplary modification of the configuration of the vehicle electronic controller 20 shown in FIG. 10. In this case, the accelerator 23 includes a GPU, and hence a part of the configurations of the host device 21, the storage unit 22, and the accelerator 23 is changed, compared with the vehicle electronic controller 20 shown in FIG. 10.

In FIG. 13, in the prediction execution control unit 210, the AI model operation processing unit enabling option setting unit 2104 shown in FIG. 10 is removed, and the AI model information setting unit 4100 is included instead. The AI model operation processing execution control unit 2105 is removed, and the AI model operation processing execution control unit 4101 is included instead.

The AI model information setting unit 4100 and the AI model operation processing execution control unit 4101 are similar to the ones described in the exemplary modification of the configuration of the vehicle electronic controller 20 according to the first embodiment, and the description is omitted.

The accelerator 23 has a configuration in which the AI model parameter information 231 shown in FIG. 10 is removed. In this configuration, the accelerator 23 does not keep holding AI model parameter information, and AI model parameter information is transferred to the accelerator 23 for every AI model operation process execution. However, a configuration may be provided in which the accelerator 23 keeps holding this information. The AI model operation processing unit 230 shown in FIG. 10 is removed, and an AI model operation processing execution unit 330 is added instead. The AI model operation processing execution unit 330 has a configuration in which an exclusive circuit specialized to the AI model installed on the vehicle electronic controller 20, i.e., a plurality of general-purpose computing units that can execute various AI models involved in the operation at high speed is installed.

<Table Information for Use in AI Model Selection according to the Exemplary Modification of the Second Embodiment>

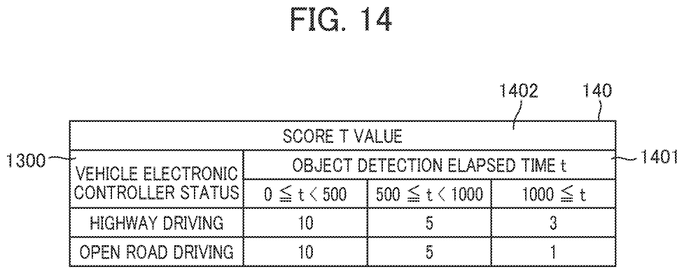

FIG. 14 is table information according to the exemplary modification of the second embodiment for use in AI model selection. This table information is used in the AI model selection score computing unit 9100 and the object-by-AI model selecting unit 9102.

FIG. 14 shows an example of a table that manages the score value for AI model selection, which is different from FIG. 11. A score T value table 140 shown in FIG. 14 is a table that manages the vehicle electronic controller status 1300, an object detection elapsed time 1401, and a score T value 1402 in association with each other.

The vehicle electronic controller status 1300 on the score T value table 140 expresses a driving scene in the embodiment, and expresses score values corresponding to expressway driving and open road driving. The object detection elapsed time 1401 is information indicating elapsed time after objects present in the surroundings of the host vehicle are detected by external sensing.

The score T value 1402 shown in FIG. 14 is the score value that is allocated corresponding to the information on the object detection elapsed time 1401. Note that a configuration may be provided in which the score T value 1402 is multiplied by a given constant to compute the score S value 1321 shown in FIG. 11(c), and hence an AI model is selected, or a configuration may be provided in which the score S value is computed to select an AI model by a given evaluation formula formed of the score D value 1302, the score P value 1311, and the score T value 1402 shown in FIGS. 11(a) to 11(b).

In the embodiment, using the score T value, a highly accurate AI model having a long processing time can be allocated to the object newly detected by sensing. To the object having a lapse of time from a new detection, the sensing result can be corrected with the combined use of an already-existing method, such as tracking. Thus, a lightweight AI model having a short processing time on the viewpoint of the load or a rule-based model is allocated. The object detection elapsed time 1401 may compute the elapsed time by the number of times of reception of data periodically inputted from the sensor other than time information, or the number of frames in the case of image data.

After a lapse of a certain time period from object detection, the score T value 1402 is varied at regular time intervals, and hence the combined use of models is allowed while a highly accurate AI model having a long processing time and a lightweight AI model having a short processing time, or a rule-based model are periodically switched. In the switching, the same AI model is not selected to all the objects in the surroundings of the host vehicle. A highly accurate AI model having a long processing time is selected to some objects, a lightweight AI model having a short processing time is selected to some objects, the model for use is periodically replaced, and hence the compatibility of prediction accuracy for each object with processing time for all the objects can be intended.

### <Operation of the Exemplary Modification of the Vehicle Electronic Controller>

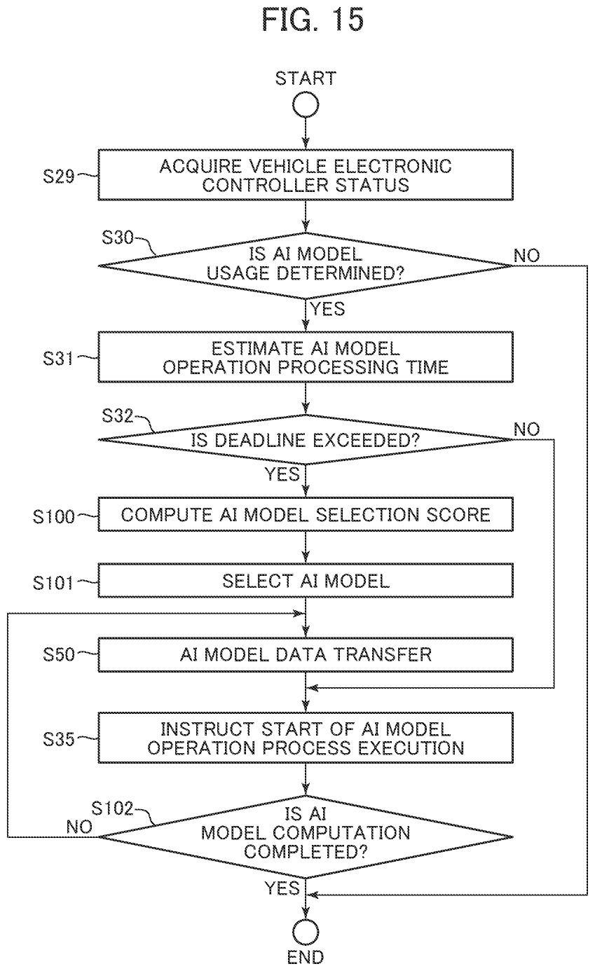

FIG. 15 is a flowchart showing the process operation of an exemplary modification of the vehicle electronic controller 20 according to the second embodiment. In FIG. 15, the same portions as the flowchart according to the first embodiment shown in FIG. 7 are designated with the same reference signs, and the description is simplified.

After the end of Step S32 shown in FIG. 15, the process transitions to Step S100. The model selection score computing unit 9100 computes a score value that selects an AI model for each object to all the objects targeted for AI model operation processing, or to all the sensed objects in the surroundings of the host vehicle.

The process transitions to Step S101. The object-by-AI model selecting unit 9102 selects an AI model the combination pattern of the operation units of the AI model for each object, i.e., the AI model based on the score value for each object computed in Step S100. After that, the process transitions to Step S50. After an AI model is selected, the AI model operation processing execution control unit 4101 transfers the AI model parameter information and the AI model structure information expanded on the memory by the AI model information setting unit 4100 to the AI model operation processing execution unit 330 of the accelerator 23. After that, the process transitions to Step S35, input data targeted for AI model operation processing is transferred to deliver the control instruction involved in operation execution start, and hence AI model operation processing is executed. After that, the process transitions to Step S102.

In Step S102, in the case in which the AI model operation processing execution completion determining unit 9101 determines that AI model operation processing is completed to all the objects, the process flow is ended. In Step S102, in the case in which it is determined that AI model operation processing is not completed to all the objects, the process transitions to Step S50, and the above-described processes are repeatedly executed until the determination in Step S102 is Yes.

According to the second embodiment, the priority level is imparted to the object based on the relative relationship between the host vehicle and the object, and a plurality of configurations of the operation unit is selected corresponding to the priority level of the object. Thus, AI model operation processing including a neural network can be completed within a desired time period in consideration of the priority level of the object.

### Third Embodiment

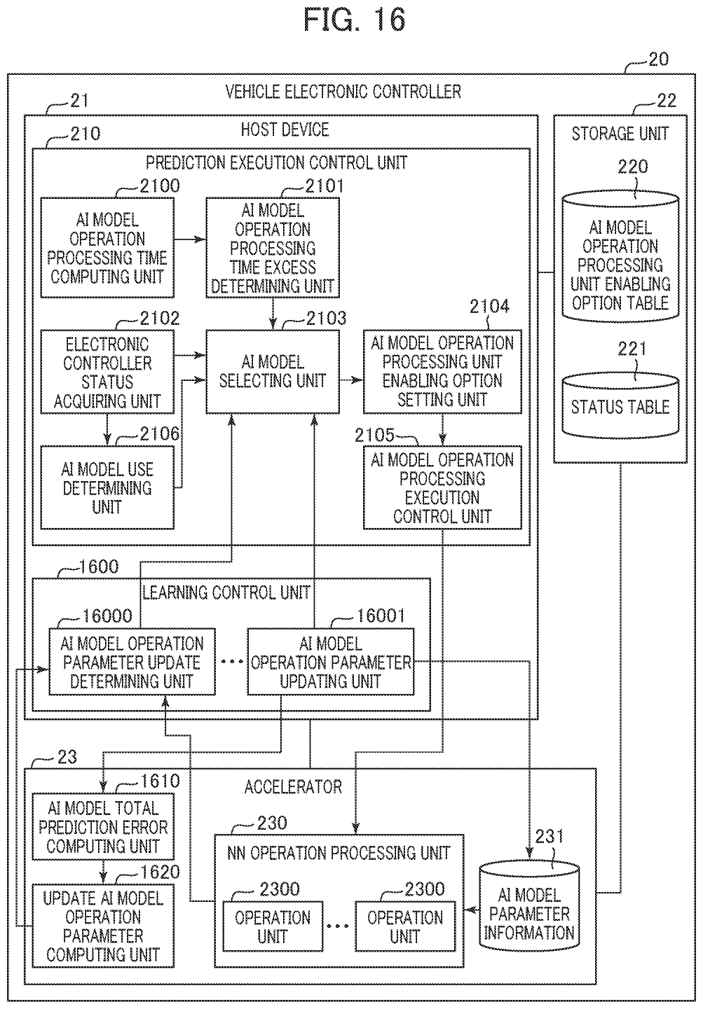

FIG. 16 is a block diagram of a vehicle electronic controller 20 according to a third embodiment. In the third embodiment, vehicle electronic controllers 20 according to the first embodiment and the second embodiment include a function that learns and updates the data of the AI model parameter information 231 to the AI model parameter information 321. The configuration of the vehicle electronic controller 20 according to the embodiment includes an FPGA or ASIC on an accelerator 23.

### <Configuration of the Vehicle Controller>

The configuration of the vehicle electronic controller 20 according to the embodiment shown in FIG. 16 is a configuration in which a learning control unit 1600 is newly added to a host device 21 and an AI model total prediction error computing unit 1610 and an update AI model operation parameter computing unit 1620 are newly added to the accelerator 23, compared with the configuration of the vehicle electronic controller 20 shown in FIG. 2.

The learning control unit 1600 is configured of an AI model operation parameter update determining unit 16000 and an AI model operation parameter updating unit 16001.

The AI model total prediction error computing unit 1610 computes an output value by an AI model that updates AI model parameter information and the prediction error value of a correct value using a loss function, such as least square error or cross entropy error. The update AI model operation parameter computing unit 1620 updates, i.e., learns AI model parameter information such that the prediction error value is at the minimum using a publicly known method referred to as error backpropagation from the prediction error value computed at the AI model total prediction error computing unit 1610. Specifically, in the case in which an error is present between the present output value by the AI model and the expected output value, AI model parameter information is updated such that the error becomes small, i.e., the degree of reliability is improved.

The AI model operation parameter update determining unit 16000 evaluates prediction accuracy on the AI model parameter information received from the accelerator 23 using evaluation data that evaluates the prediction accuracy of the AI model, and hence the AI model operation parameter update determining unit 16000 determines whether the AI model parameter information stored on the AI model parameter information 231 is updated. Note that a method of computing prediction accuracy from evaluation data is the procedures similar to AI model operation processing described social far, and input data targeted for AI model operation processing only has to be evaluation data.

The AI model operation parameter updating unit 16001 updates and controls the AI model parameter information on the AI model parameter information 231. The AI model parameter information on the AI model parameter information 231 is updated based on the determination result from the AI model operation parameter update determining unit 16000. The update, i.e., learning of the AI model parameter information is requested to the AI model total prediction error computing unit 1610, described later.

### <Exemplary Modification of the Configuration of the Vehicle Electronic Controller>

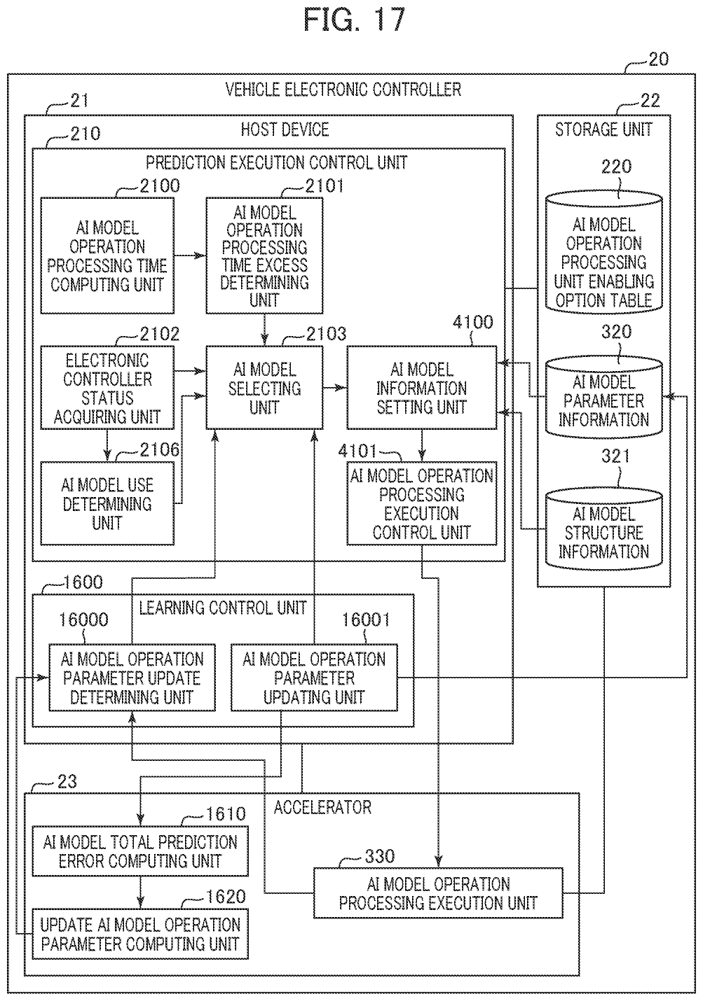

FIG. 17 is a block diagram showing an exemplary modification of the configuration of the vehicle electronic controller 20 according to the third embodiment. In the embodiment, the accelerator 23 includes a GPU, and hence a part of the configurations of the host device 21, the storage unit 22, and the accelerator 23 is changed, compared with the vehicle electronic controller 20 shown in FIG. 16. However, any processing unit is similar to ones described in the first embodiment, and the description is omitted.

Note that in the embodiment, on the learning of the AI model parameter information in FIGS. 16 and 17, a plurality of AI models is used for operation corresponding to the combination of the operation units. However, learning may be possible such that AI model parameter information is shared between the operation units of the plurality of AI models. Specifically, the AI model total prediction error computing unit 1610 computes a prediction error on all the AI models installed on the vehicle electronic controller 20. The total of prediction errors computed on each of the AI models is computed, the AI model parameter information is updated such that the value is at the minimum, and hence learning can be implemented. With this configuration, the AI model parameter can be made standardized between the operation units of the plurality of AI models, and it is unnecessary to hold AI model parameter information on each of the AI models. Thus, an increase in the capacity necessary to the storage unit is avoided, and hardware costs can be suppressed.

According to the embodiments described above, the following operation and effect are obtained.

(1) The vehicle electronic controller 20 includes the status acquiring unit 2102 configured to acquire the status of a vehicle and the determining unit 2106 configured to determine whether an artificial intelligence model is configured based on the status of the vehicle acquired at the status acquiring unit 2102. In the case in which the determining unit 2106 determines that the artificial intelligence model is configured, an artificial intelligence model configured to execute a predetermined process is configured by the combination of a plurality of operation units. Thus, based on the status of the vehicle the artificial intelligence model is configured, and processing time necessary to operation processing can be reduced.

(2) In the case in which a predetermined process is not completed within a predetermined time period, the vehicle electronic controller 20 determines whether to configure an artificial intelligence model using any of the plurality of operation units, and executes a predetermined process. Thus, the artificial intelligence model is configured, and processing time necessary to operation processing can be reduced.

(3) The artificial intelligence model of the vehicle electronic controller 20 is a neural network is configured of the input layer 10 configured to accept an external signal, the output layer 12 configured to externally output the operation result, and the intermediate layer 11 configured of a plurality of operation units 2300, the intermediate layer 11 applying a predetermined process to information accepted from the input layer 10, the intermediate layer 11 outputting the process result of a predetermined process to the output layer 12. The configuration of the intermediate layer 11 is selected corresponding to the status of a vehicle acquired at the status acquiring unit 2102. Thus, processing time necessary to AI model operation processing including a neural network is reduced, an increase in the consumption of the hardware resources of a hardware accelerator that executes AI model operation processing is not increased as much as possible, and hence the artificial intelligence model can be implemented

(4) The status of the vehicle of the vehicle electronic controller 20 is a host vehicle driving environment including the number of objects present in the surroundings of the vehicle. Thus, an AI model corresponding to the number of objects can be constructed.

(5) The status of the vehicle of the vehicle electronic controller 20 is a host vehicle driving environment including the driving scene of the vehicle. Thus, an AI model suitable for the driving scene can be constructed.

(6) The status of the vehicle of the vehicle electronic controller 20 is a host vehicle driving environment including the weather at the driving point of the vehicle. Thus, an AI model suitable for the weather at the driving point of the vehicle can be constructed.

(7) The status of the vehicle of the vehicle electronic controller 20 is a host vehicle driving environment including the time slot at which the vehicle is driving. Thus, an AI model corresponding to the time slot at which the vehicle is driving can be constructed.

(8) The status of the vehicle of the vehicle electronic controller 20 is a host vehicle driving environment including the device status of the vehicle. Thus, an AI model corresponding to the device status of the vehicle, the presence or absence of failure occurrence, and the load state of the CPU or the accelerator, for example, can be constructed.

(9) The vehicle electronic controller includes an enabling unit table in which the enabling or disabling the operation unit is set corresponding to the status of the vehicle. The neural network is configured with the combination a plurality of operation units that are enabled based on the enabling unit table. Thus, a plurality of operation units can be combined.

(10) The neural network determines whether to use any of the plurality of operation units for configuration corresponding to the number of objects. Thus, even in the case in which the number of objects is increased, for example, processing time necessary to operation processing can be reduced.

(11) The neural network determines whether to use any of the plurality of operation units for configuration with imparting the priority level the object based on the status of the vehicle. Thus, in consideration of the priority level of the object, processing time necessary to AI model operation processing including a neural network can be reduced.

(12) The priority level is imparted based on the relative relationship between the host vehicle and the object. Thus, in consideration of the priority level of the object, processing time necessary to AI model operation processing including a neural network can be reduced.

(13) The storage unit configured to store the operation parameter of the plurality of operation units is included. In the neural network, the operation parameter is updated such that the degree of reliability of the output value from the output layer in the status of the vehicle is improved. Thus, the operation error in AI model operation processing can be reduced.

The present invention is not limited to the foregoing embodiments. Other forms considered within the gist of the technical idea of the present invention are also included in the gist of the present invention, as long as the features of the present invention are not impaired. Configurations may be provided in which the foregoing embodiments are combined.

The content of the disclosure of the following basic application for priority is incorporated herein by reference.

Japanese Patent Application No. 2017-089825 (filed on Apr. 28, 2017)

### REFERENCE SIGNS LIST

1: neural network model
10: input layer
11: intermediate layer
12: output layer
20: vehicle electronic controller
21: host device
22: storage unit
23: accelerator
210: prediction execution control unit
220: AI model operation processing unit enabling option table
230: AI model operation processing unit
231: AI model parameter information
2100: AI model operation processing time computing unit
2101: AI model operation processing time excess determining unit
2102: electronic controller status acquiring unit
2103: AI model selecting unit
2104: AI model operation processing unit enabling option setting unit
2105: AI model operation processing execution control unit
2106: AI model usage determining unit
2300: operation unit
S30: application processing time estimation process
S31: deadline excess determination process
S32: electronic controller status acquiring process
S33: AI model selection process
S34: operation unit enabling option setting process
S35: AI model operation process execution start instruction process
420: AI model parameter information
421: AI model structure information
4100: AI model information setting unit
430: AI model operation processing execution unit
S50: AI model data transfer
60: object number-to-model ID correspondence table
61: driving scene-to-model ID correspondence table
600: model ID
601: object number information
611: driving scene information
62: weather-to-model ID correspondence table
621: weather information
63: time slot-to-model ID correspondence table
631: time slot information
64: device status-to-model ID correspondence table
641: device status
70: operation unit
71: AI model
700: convolution layer
701: batch normalization
702: activation function
703: pooling layer
704: fully connected layer
705: LSTM layer
80: enabling/disabling switching function-equipped operation unit
81: enabling switching time operation unit
82: disabling switching time operation unit
83: enabling/disabling switching function-equipped AI model
84: model pattern 1
85: model pattern 2
86: model pattern 3
9100: AI model selection score computing unit
9101: AI model operation processing execution completion determining unit
9102: object-by-AI model selecting unit
S100: neural net model selection score computing process
S101: neural net model operation completion determination process
130: score T value table
1300: vehicle electronic controller status
1301: relative distance D
1302: score T value
131: score P value table
1310: future track existence presence/absence information
1311: score P value
132: score S value table
1320: model ID
1321: score S value
140: score T value table
1401: object detection elapsed time
1402: score T value
1500: operation unit ID
1501: operation unit enabling option information
1600: learning control unit
1610: AI model total prediction error computing unit
1620: update AI model operation parameter computing unit
16000: AI model operation parameter update determining unit
16001: AI model operation parameter updating unit

1. A vehicle electronic controller comprising:
a status acquiring unit configured to acquire status of a vehicle; and
a determining unit configured to determine whether to configure an artificial intelligence model based on the status of the vehicle acquired at the status acquiring unit,
wherein when the determining unit determines that the artificial intelligence model is configured, an artificial intelligence model configured to execute a predetermined process is configured by combination of a plurality of operation units.

2. The vehicle electronic controller according to claim 1,
wherein when the predetermined process is not completed within a predetermined time period, it is determined whether to configure the artificial intelligence model using any of a plurality of the operation units, and the predetermined process is executed.

3. The vehicle electronic controller according to claim 2,
wherein the artificial intelligence model is a neural network configured of an input layer configured to accept an external signal, an output layer configured to externally output an operation result, and an intermediate layer configured of the plurality of the operation units, the intermediate layer applying the predetermined process to information accepted from the input layer, the intermediate layer outputting a process result of the predetermined process to the output layer; and
a configuration of the intermediate layer is selected corresponding to the status of the vehicle acquired at the status acquiring unit.

4. The vehicle electronic controller according to claim 3,
wherein the status of the vehicle is a host vehicle driving environment including a number of objects present in surroundings of the vehicle.

5. The vehicle electronic controller according to claim 3,
wherein the status of the vehicle is a host vehicle driving environment including a driving scene of the vehicle.

6. The vehicle electronic controller according to claim 3,
wherein the status of the vehicle is a host vehicle driving environment including weather at a driving point of the vehicle.

7. The vehicle electronic controller according to claim 3,
wherein the status of the vehicle is a host vehicle driving environment including a time slot at which the vehicle is driving.

8. The vehicle electronic controller according to claim 3,
wherein the status of the vehicle is a host vehicle driving environment including device status of the vehicle.

9. The vehicle electronic controller according to claim 3, comprising
an enabling unit table in which enabling/disabling of the operation unit is set corresponding to the status of the vehicle,
wherein the neural network is configured in which the operation unit is enabled based on the enabling unit table, and the plurality of the operation units is combined.

10. The vehicle electronic controller according to claim 4,
wherein the neural network is determined whether to configure using any of the plurality of the operation units corresponding to a number of the objects.

11. The vehicle electronic controller according to claim 4,
wherein a priority level is imparted to an object based on the status of the vehicle; and
The neural network is determined whether to configure using any of the plurality of the operation units corresponding to the priority level of the object.

12. The vehicle electronic controller according to claim 11,
wherein the priority level is imparted based on relative relationship between a host vehicle and the object.

13. The vehicle electronic controller according to claim 3, comprising
a storage unit configured to store an operation parameter of the plurality of the operation units,
wherein in the neural network, the operation parameter is updated such that a degree of reliability of an output value from the output layer is improved in the status of the vehicle.
